(19) United States
(12) Patent Application Publication
(10) Pub. No.: US 2017/0105039 A1
(43) Pub. Date: Apr. 13, 2017

(54) SYSTEM AND METHOD OF SYNCHRONIZING A VIDEO SIGNAL AND AN AUDIO STREAM IN A CELLULAR SMARTPHONE

(71) Applicant: DAVID B. RIVKIN, BURBANK, CA (US)

(72) Inventors: DAVID B. RIVKIN, BURBANK, CA (US); ANGEL A. OLIVERA, PLANTATION, FL (US)

(73) Assignee: DAVID B. RIVKIN, BURBANK, CA (US)

(21) Appl. No.: 15/133,663

(22) Filed: Apr. 20, 2016

Related U.S. Application Data
(60) Provisional application No. 62/156,965, filed on May 5, 2015.

(51) Int. Cl. H04N 21/43; G10L 19/008; H04H 60/04; H04N 21/439; H04N 21/6437; H04N 21/81; G10L 21/055; G10L 19/16

(52) U.S. Cl. CPC H04N 21/4307; G10L 21/055; G10L 19/008; G10L 19/167; H04N 21/4398; H04N 21/6437; H04N 21/8106; H04H 60/04

(57) ABSTRACT

A system and method of enhancing the quality of the sound in a cellular smartphone used at a live event. A video signal is captured from a live event in a smartphone camera of a cellular smartphone to create a video clip. A plurality of audio signals are received from the live event and processed to provide a mixed stereo audio signal. The mixed stereo audio signal is converted to a digital stereo audio signal. The digital stereo audio signal is encoded to provide an encoded stereo audio signal. The encoded stereo audio signal is streamed as an encoded stereo audio stream. The encoded stereo audio stream is captured in the cellular smartphone. The captured encoded stereo audio stream is combined and synchronized with the video clip by utilizing timestamps. Thus, a completed movie clip with enhanced quality sound is provided.

### CROSS REFERENCE TO RELATED APPLICATIONS

This application claims the benefit of U.S. Provisional Application Ser. No. 62/156,965, filed on May 5, 2015, the entire contents of which are hereby incorporated herein by reference thereto.

### BACKGROUND OF THE INVENTION

1. Field of the Invention

The present invention relates generally to recording video and capturing audio in a smartphone application, and more particularly to synchronizing the video signal and audio stream obtained from a live event to generate an enhanced quality sound.

2. Description of the Related Art

Videos of events recorded on a smartphone have a poor audio quality because of a combination of, distance from the sound source, and the smartphone's small internal microphone. Louder noises, such as crowd noise will overload the microphone also causing extreme distortion.

U.S. Pat. Publcn. No. 2006/0030343 A1, to Ebner, et al. entitled, “METHOD FOR DECENTRALIZED SYNCHRONIZATION IN A SELF-ORGANIZING RADIO COMMUNICATION SYSTEM,” discloses a method that performs synchronization in an at least partly self-organizing radio communication system with a number of mobile stations which lie across an air interface within two-way radio range. At least some mobile stations from the number of mobile stations transmit synchronization sequences, by which a part or all the mobile stations of the number of mobile stations synchronize.

### SUMMARY OF THE INVENTION

In a broad aspect, the present invention is method of enhancing the quality of the sound in a cellular smartphone used at a live event. A video signal is captured from a live event in a smartphone camera of a cellular smartphone to create a video clip. A plurality of audio signals are received from the live event and processed to provide a mixed stereo audio signal. The mixed stereo audio signal is converted to a digital stereo audio signal. The digital stereo audio signal is encoded to provide an encoded stereo audio signal. The encoded stereo audio signal is streamed as an encoded stereo audio stream. The encoded stereo audio stream is captured in the cellular smartphone. The captured encoded stereo audio stream is combined and synchronized with the video clip by utilizing timestamps. Thus, a completed movie clip with enhanced quality sound is provided.

In one preferred embodiment, the combining and synchronizing step comprises utilizing a drift calculation algorithm.

One advantage of this invention is improved clarity of any sound source that is processed.

Other objects, advantages, and novel features will become apparent from the following detailed description of the invention when considered in conjunction with the accompanying drawings.

### BRIEF DESCRIPTION OF THE DRAWINGS

FIG. 1 is flow chart of the method of enhancing the quality of the sound in a cellular smartphone used at a live event, in accordance with the principles of the present invention.

FIG. 2A (Prior Art) shows the frequency response from a smartphone camera microphone at an event, without utilization of the present invention.

FIG. 2B shows the frequency response at the same event utilizing the present invention.

FIG. 3A is a schematic representation of the video and audio tracks illustrating the drift between the audio and the video, where the audio track is longer than the video track, showing synchronization in accordance with the principles of the present invention.

FIG. 3B is a schematic representation of the video and audio tracks illustrating the drift between the audio and the video, where the video track is longer than the audio track, showing synchronization in accordance with the principles of the present invention.

### DETAILED DESCRIPTION OF THE INVENTION

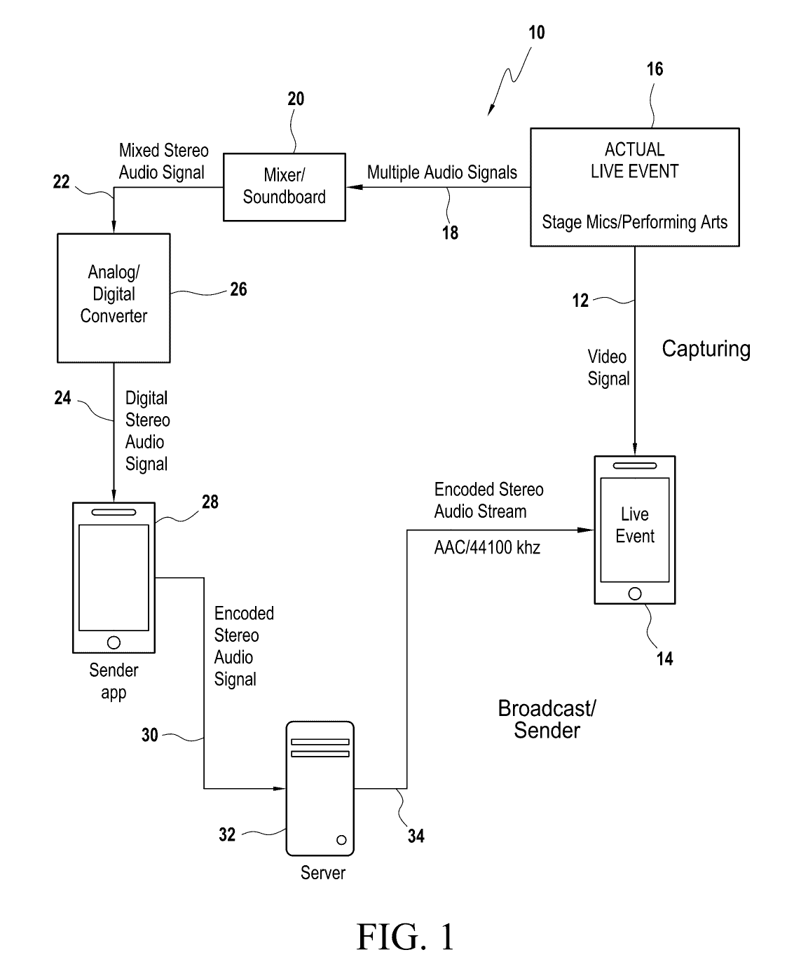

Referring now to the drawings and the characters of reference marked thereon, FIG. 1 illustrates the method and system of the present invention, designated generally as 10. A video signal 12 is captured in a smartphone camera of a cellular smartphone 14 at a live event 16, to create a video clip. The cellular smartphone may be any type of commercially available smartphone such as an IPhone, IPad, android, Windows phone, or IOS device. The live event 16 may typically be, for example, a concert, sporting event, or public speaking event such as classrooms and religious services, etc.

A plurality of audio signals 18 from the live event 16 are received and processed by a mixer 20. Thus, a mixed stereo audio signal 22 is provided. The mixer 20 may be a digital mixer or an analog mixer, as is well known in this field.

The mixed stereo audio signal 22 is converted to a digital stereo audio signal 24 by an analog to digital converter 26. Alternately, the mixed stereo audio signal 22 may be converted by a digital to digital converter.

A sender application 28 encodes the digital stereo audio signal 24 to provide an encoded stereo audio signal 30. As used herein the term “sender application” refers to a program designed to encode the digital stereo audio signal 24.

The encoded stereo audio signal 30 is streamed by a server 32 as an encoded stereo audio stream 34.

The encoded stereo audio stream 34 is captured in the cellular smartphone 14 by a receiver application.

The captured encoded stereo audio stream is combined and synchronized with the video clip by the receiver application by utilizing timestamps, providing a completed movie clip with enhanced quality sound.

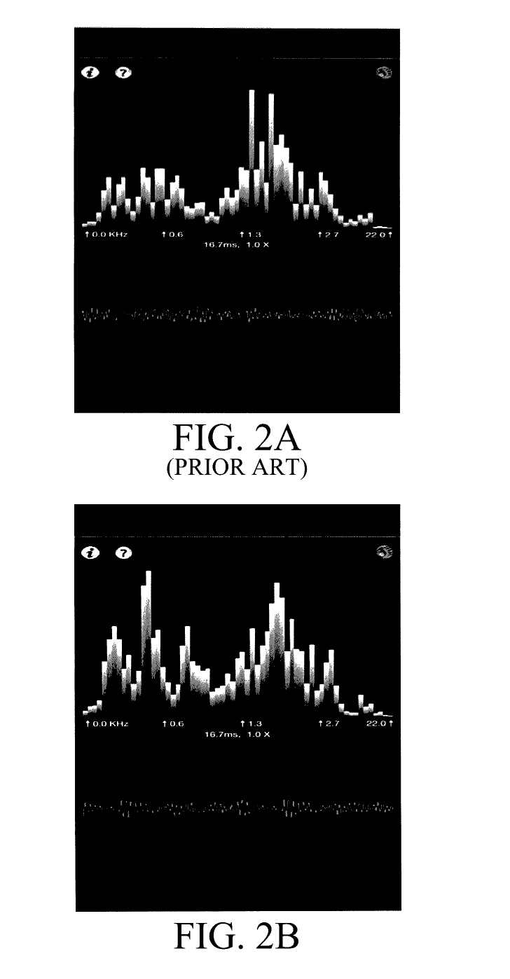

FIG. 2A shows the frequency response from a smartphone camera microphone at an event. This data was measured using an audio spectrum analyzer divided into 512 frequencies ranging from 10 Hz to 20 Kilohertz. A SoundView version 2-4 spectrum analyzer, developed by Rare Works, LLC, Austin, Tex., was used in both tests. The measurement was taken at the playback of two examples of a video recorded at a music concert from the same smartphone. FIG. 2B shows the frequency response utilizing the present invention. The data was measured at separate times with the phone in the exact same location with the volume of playback set at the same level. FIG. 2B shows a wider range and enhanced distribution of frequencies than FIG. 2A. Subsequently, a higher fidelity recording is achieved using the present invention.

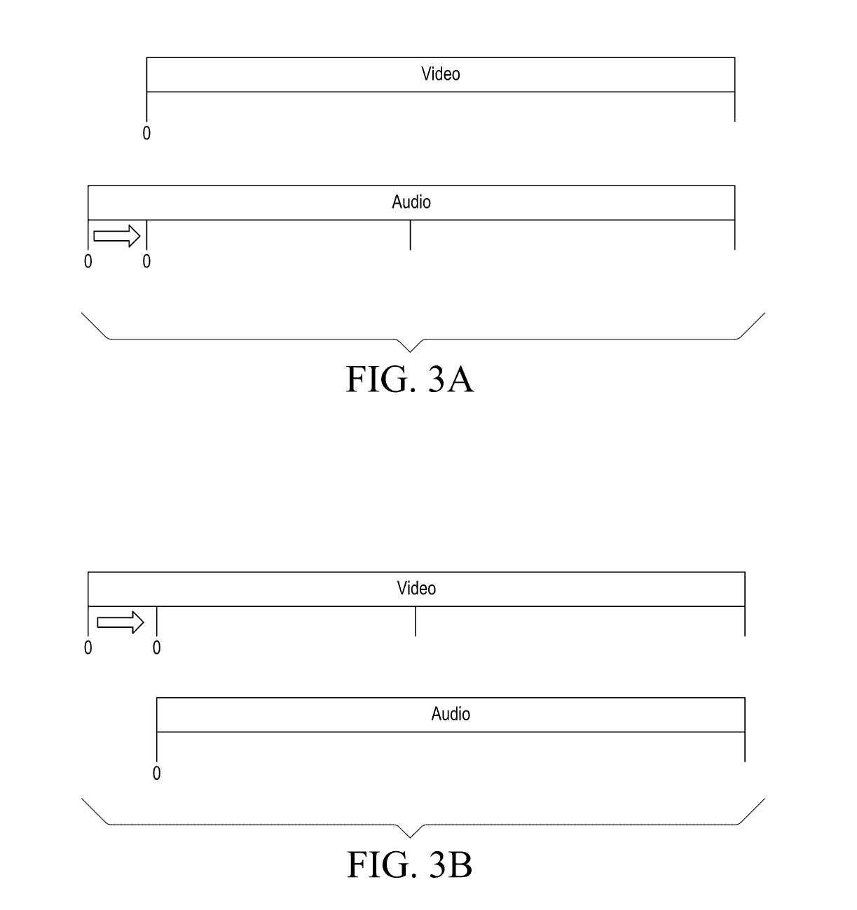

Referring now to FIGS. 3A and 3B the synchronization process of the present invention is illustrated. The invention utilizes an algorithm for calculating the drift between audio and video. This algorithm uses a sequence of encoded information (known as a timestamp) which identifies when an event occurred, in this case the date, start time and end time of video and audio recorded. The algorithm will then calculate the start and end times to give the length of the audio track and video track. The figures are shown to illustrate the algorithm used depending on the length of each track. FIG. 3A shows if the audio has a longer track then the video, the algorithm will shift the start time of the audio to match the start time of the video thus making the audio track the same length. FIG. 3B shows what happens if the video track is a longer track then the audio track, the algorithm uses the timestamps and shifts the video track start time to match the start time of the audio track. Once the video track and audio track are the same length and start times are correct, the audio and video will be synchronized.

1. A method of enhancing the quality of the sound in a cellular smartphone used at a live event, comprising:
a) capturing a video signal from a live event in a smartphone camera of a cellular smartphone to create a video clip;
b) receiving a plurality of audio signals from the live event and processing said plurality of audio signals to provide a mixed stereo audio signal;
c) converting the mixed stereo audio signal to a digital stereo audio signal;
d) encoding said digital stereo audio signal to provide an encoded stereo audio signal;
e) streaming said encoded stereo audio signal as an encoded stereo audio stream;
f) capturing said encoded stereo audio stream in said cellular smartphone; and,
g) combining and synchronizing the captured encoded stereo audio stream with the video clip by utilizing timestamps, providing a completed movie clip with enhanced quality sound.

2. The method of claim 1, wherein said combining and synchronizing step comprises utilizing a drift calculation algorithm.

3. The method of claim 1, wherein said encoded stereo audio stream comprises a compressed audio signal using the AAC protocol with a sample rate of 44100 kHz.

4. The method of claim 1, wherein said encoded stereo audio stream comprises a compressed audio signal conforming to RFC 2336 section 10.11 10.11 RECORD.

5. The method of claim 1, wherein said step of receiving a plurality of audio signals from the live event and processing said plurality of audio signals comprises utilizing a mixer.

6. The method of claim 1, wherein said step of encoding said digital stereo audio signal comprises converting an uncompressed digital stereo audio signal to a compressed format thus generating an AAC encoded stereo audio signal with a sample rate of 44100 kHz.

7. The method of claim 1, wherein said encoded stereo audio stream comprises a real time streaming protocol (RTSP).

8. A system of enhancing the quality of the sound in a cellular smartphone used at a live event, comprising:
a) a smartphone camera of a cellular smartphone for capturing a video signal from a live event to create a video clip;
b) a mixer for receiving a plurality of audio signals from the live event and processing said plurality of audio signals to provide a mixed stereo audio signal;
c) an analog/digital converter for converting the mixed stereo audio signal to a digital stereo audio signal;
d) a sender application for encoding said digital stereo audio signal to provide an encoded stereo audio signal;
e) a server for streaming said encoded stereo audio signal as an encoded stereo audio stream, wherein
said encoded stereo audio stream is captured in said cellular smartphone by a receiver application, wherein said receiver application combines and synchronizes the captured encoded stereo audio stream with the video clip by utilizing timestamps, providing a completed movie clip with enhanced quality sound.

9. The system of claim 8, wherein said receiver application combines and synchronizes utilizing a drift calculation algorithm.

10. The system of claim 8, wherein said encoded stereo audio stream comprises a compressed audio signal using the AAC protocol with a sample rate of 44100 kHz.

11. The system of claim 8, wherein said encoded stereo audio stream comprises a compressed audio signal conforming to RFC 2336 section 10.11 10.11 RECORD.

12. The system of claim 8, wherein said wherein said encoded stereo audio stream comprises a real time streaming protocol (RTSP).
